(19) United States
(12) Patent Application Publication
(10) Pub. No.: US 2016/0084699 A1
(43) Pub. Date: Mar. 24, 2016

(54) FOOD ITEM SCALES, METHODS FOR CALIBRATING SAME, AND METHODS FOR DETERMINING THE WEIGHT OF FOOD ITEMS

(71) Applicant: General Electric Company, Schenectady, NY (US)

(72) Inventor: Keith Wesley Wait, Louisville, KY (US)

(21) Appl. No.: 14/490,696

(22) Filed: Sep. 19, 2014

(51) Int. Cl. G01G 23/01; G01G 3/14

(52) U.S. Cl. CPC G01G 23/01; G01G 3/14

(57) ABSTRACT

Food item scales, methods for determining the weight of food items, and methods for calibrating food item scales are provided. A method for determining a weight of a food item includes receiving a voltage signal and a sine wave generator signal, capturing a first voltage signal value at a first trigger datum and a second voltage signal value at a second trigger datum, and determining the weight based on the first voltage signal value and the second voltage signal value.

### FIELD OF THE INVENTION

The present disclosure related generally to food item scales and associated methods. In particular, the present disclosure is related to the calibration of food item scales and the measurement of food items using such scales.

### BACKGROUND OF THE INVENTION

While rudimentary scales for measuring the weight of various items are well known, the use of “smart” scales which are, for example, connected to independent storage devices such as smart phones and able to transmit data to such devices is a relatively recent development. One particular application of such scales is in the measurement of food items, such as a container of milk, which may be typically housed in a refrigerator appliance. This allows a user to, for example, easily confirm whether they are out of the particular food item when at the grocery store.

One issue with food item scales generally is the expense associated with the scales. Typically, precision springs or load cells with attached strain gauges are utilized to sense the weight of a food item placed on the scale. These components are generally expensive, and additionally can be affected by temperature changes. This can be particularly undesirable in applications wherein the food item scale is disposed within a refrigerator.

Accordingly, improved food item scales and associated methods are desired. In particular, food item scales and associated methods which are inexpensive while providing accurate performance outputs in a variety of environments would be advantageous.

### BRIEF DESCRIPTION OF THE INVENTION

Additional aspects and advantages of the invention will be set forth in part in the following description, or may be apparent from the description, or may be learned through practice of the invention.

In accordance with one embodiment, a food item scale is provided. The food item scale includes a force sensitive resistor, a signal conditioning circuit connected to the force sensitive resistor, and a controller. The controller is configured for receiving a voltage signal and a sine wave generator signal from the signal conditioning circuit, capturing a first voltage signal value at a first trigger datum and a second voltage signal value at a second trigger datum, and determining a weight of the food item based on the first voltage signal value and the second voltage signal value.

In accordance with another embodiment, a method for determining a weight of a food item is provided. The method includes receiving a voltage signal and a sine wave generator signal, capturing a first voltage signal value at a first trigger datum and a second voltage signal value at a second trigger datum, and determining the weight based on the first voltage signal value and the second voltage signal value.

In accordance with another embodiment, a method for calibrating a food item scale is provided. The method includes detecting a food item weight transition from a first weight to a second weight. The method further includes determining, when the food item weight transition is positive, if the second weight is greater than a full weight threshold value. The method further includes setting a full weight value as equal to the second weight when the second weight is greater than the full weight threshold value.

In accordance with another embodiment, a method for calibrating a food item scale is provided. The method includes detecting a food item weight transition from a first weight to a second weight. The method further includes determining, when the food item weight transition is negative, if the second weight is less than an empty weight threshold value. The method further includes setting an empty weight value as equal to the second weight value when the second weight is less than the empty weight threshold value.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a refrigerator appliance according to an exemplary embodiment of the present subject matter;

FIG. 2 provides a front view of the refrigerator appliance of FIG. 1 with refrigerator doors of the refrigerator appliance shown in an open configuration to reveal a fresh food chamber and freezer chamber of the refrigerator appliance, with a food item scale disposed within the fresh food chamber;

FIG. 3 is a perspective view of a food item scale, with a top panel of a housing removed such that the internal components are visible, in accordance with one embodiment of the present disclosure;

FIG. 4 is a diagram of a signal conditioning circuit connected to a force sensitive resistor and a controller in accordance with one embodiment of the present disclosure;

FIG. 5 is a graph illustrating outputs of the signal conditioning circuit and the force sensitive resistor;

FIG. 6 is a flow chart illustrating a method for determining a weight of a food item in accordance with one embodiment of the present disclosure;

FIG. 7 is a chart providing an illustrative example of food item weights measured over a sample time period, along with example full weight values and empty weight values based on the food item weights measured over the sample time period in accordance with one embodiment of the present disclosure; and

FIG. 8 is a flow chart illustrating a method for calibrating a food item scale in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

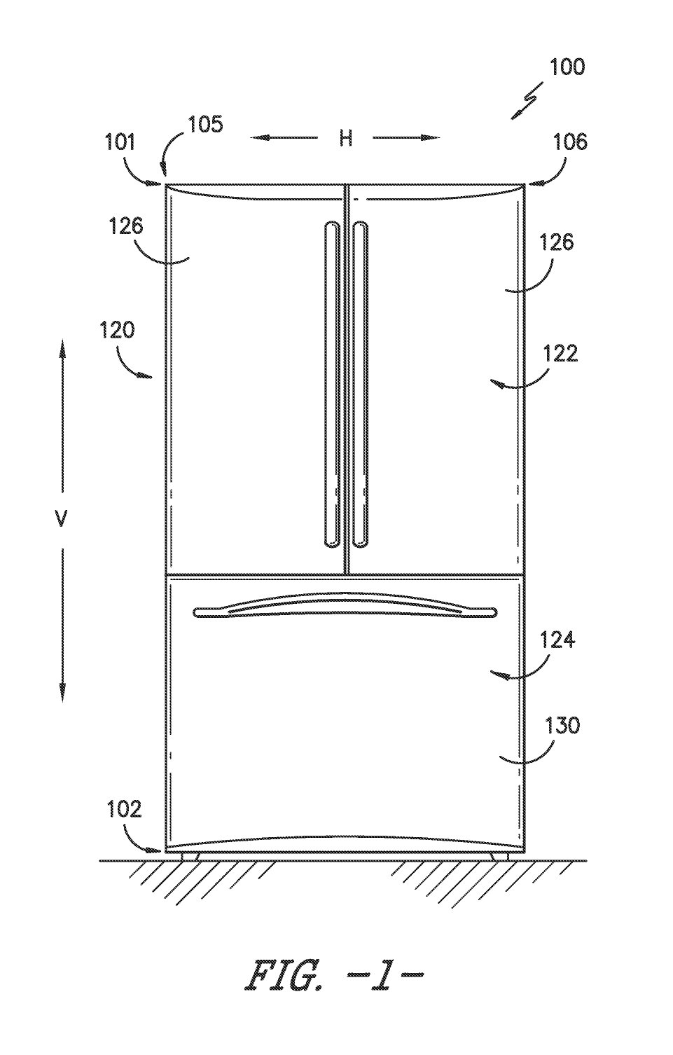

FIG. 1 is a front view of an exemplary embodiment of a refrigerator appliance 100. Refrigerator appliance 100 extends between a top 101 and a bottom 102 along a vertical direction V. Refrigerator appliance 100 also extends between a first side 105 and a second side 106 along a horizontal direction H. A transverse direction T may additionally be defined perpendicular to the vertical and horizontal directions V, H.

Refrigerator appliance 100 includes a cabinet or housing 120 defining an upper fresh food chamber 122 and a lower freezer chamber 124 arranged below the fresh food chamber 122 on the vertical direction V. As such, refrigerator appliance 100 is generally referred to as a bottom mount refrigerator. In the exemplary embodiment, housing 120 also defines a mechanical compartment (not shown) for receipt of a sealed cooling system (not shown). Using the teachings disclosed herein, one of skill in the art will understand that the present invention can be used with other types of refrigerators (e.g., side-by-sides) or a freezer appliance as well. Consequently, the description set forth herein is for illustrative purposes only and is not intended to limit the invention in any aspect.

Refrigerator doors 126 are rotatably hinged to an edge of housing 120 for accessing fresh food chamber 122. It should be noted that while two doors 126 in a “french door” configuration are illustrated, any suitable arrangement of doors utilizing one, two or more doors is within the scope and spirit of the present disclosure. A freezer door 130 is arranged below refrigerator doors 126, 128 for accessing freezer chamber 124. In the exemplary embodiment, freezer door 130 is coupled to a freezer drawer (not shown) slidably coupled within freezer chamber 124.

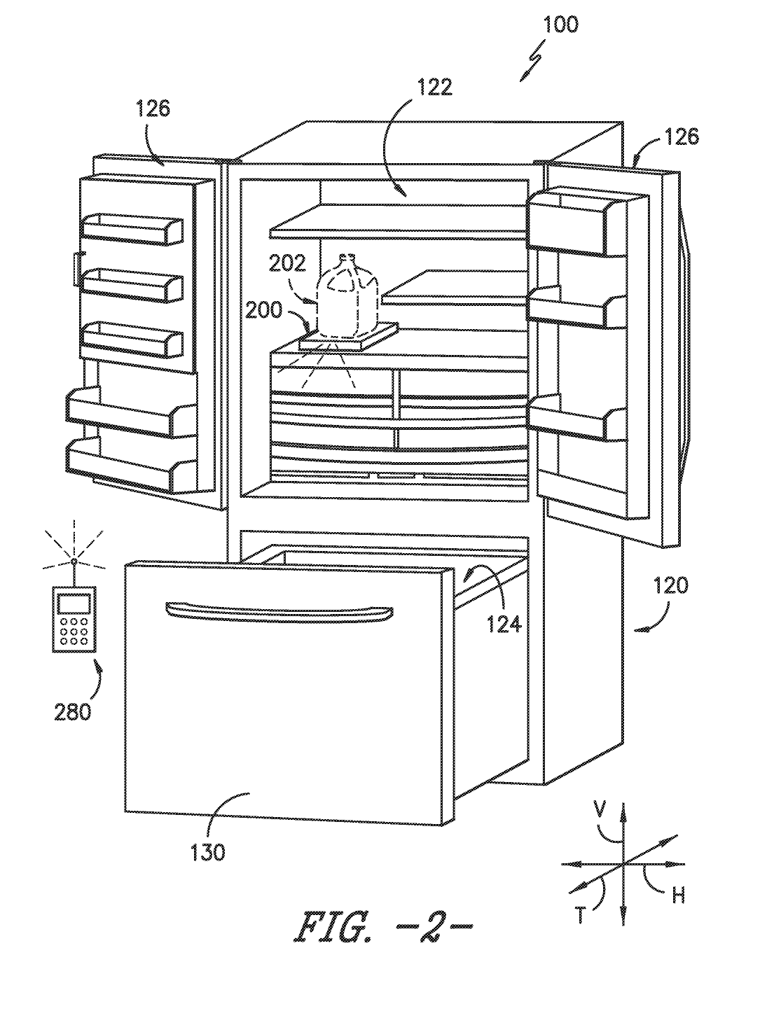

FIG. 2 is a perspective view of refrigerator appliance 100 having refrigerator doors 126, 128 in an open position to reveal the interior of the fresh food chamber 122. Additionally, freezer door 130 is shown in an open position to reveal the interior of the freezer chamber 124.

As further illustrated in FIG. 2, a food item scale 200 may be disposed within the refrigerator appliance 100, such as within fresh food chamber 122. The food item scale 200 can be utilized to determine the weight of a food item 202 placed on the scale 200. For example, in exemplary embodiments, the particular food item 202 to be weighed by the scale 200 is a container of milk, as illustrated. Alternatively, however, any suitable food item 202, liquid or solid, fresh or frozen, is within the scope and spirit of the present disclosure. Notably, food item scales 200 in exemplary embodiments are intended for use with only a single food item 202, for which a full weight of the food item 202 is generally known. This facilitates both determination of the weight of the food item 202 and calibration of the scale 200. Food item scale 200 may be provided on a shelf within the refrigerator appliance 100, or may be built into a shelf or other suitable component of the refrigerator appliance 100. It should be understood, however, that the present disclosure is not limited to food item scales 200 utilized in refrigerator appliances 100. Rather, food item scales 200 being utilized in any suitable environment, independently of or in conjunction with another appliance, are within the scope and spirit of the present disclosure.

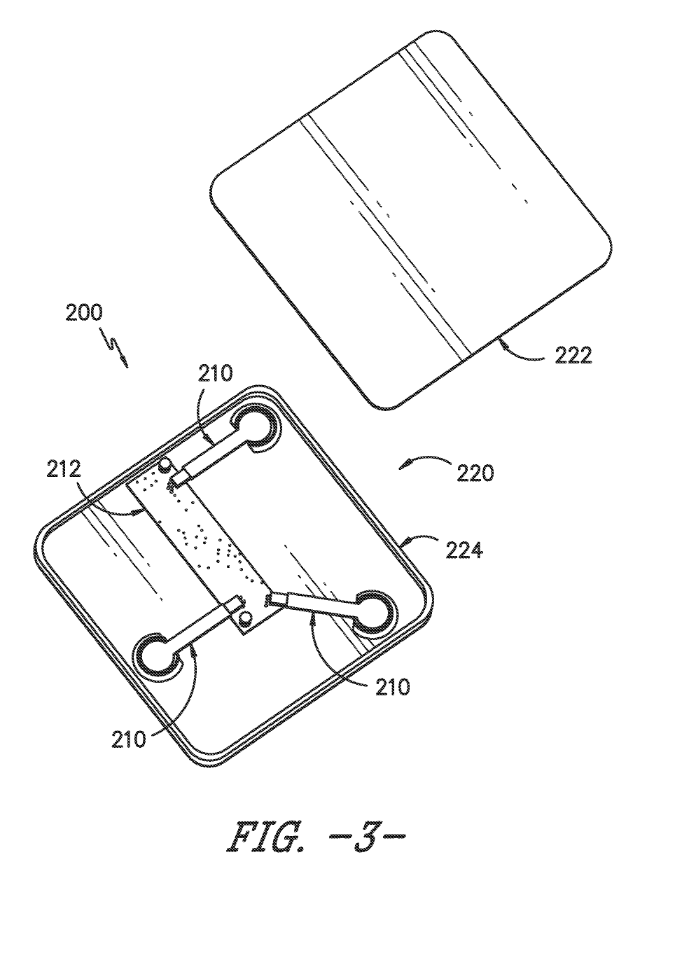

FIG. 3 illustrates one embodiment of a food item scale 200. The food item scale 200 as illustrated includes one or more force sensitive resistors 210. Scale 200 further includes one or more signal conditioning circuits 212, each of which is connected to one or more force sensitive resistors 210. A controller 214 may additionally be provided, and may be connected to the signal conditioning circuit(s) 212. Controller 214 in exemplary embodiments may include an analog-to-digital converter 216, which may be integral with the controller 214 or a separate component connected to the controller 214, such as between signal conditioning circuit(s) 212 and the controller 214. Accordingly, electrical signals from the force sensitive resistors 210 may be provided through the signal conditioning circuits 212 to the controller 214, and additional electrical signals from the signal conditioning circuits 212 may be provided to the controller 214.

The controller 214 may include a memory and one or more microprocessors, CPUs or the like, such as general or special purpose microprocessors operable to execute programming instructions or micro-control code associated with operation of food item scale 200. The memory may represent random access memory such as DRAM, or read only memory such as ROM or FLASH. In one embodiment, the processor executes programming instructions stored in memory. The memory may be a separate component from the processor or may be included onboard within the processor. Input/output (“I/O”) signals may be routed between the controller and various operational components of food item scale 200, as well as other suitable apparatus, via suitable wired or wireless connections as is generally understood.

The force sensitive resistors 210 and signal conditioning circuit(s) 212 may in exemplary embodiments be disposed within a housing 220. The housing may, for example, include a top panel 222 and a base 224. The force sensitive resistors 210 and signal conditioning circuit(s) 212 may be disposed on the base 224, and the top panel 222 may be provided on the base 224 to generally enclose the force sensitive resistors 210 and signal conditioning circuit(s) 212.

During operation, a food item 202 may be placed on the scale 200, such as on the top panel 222 thereof. When such force is applied by the food item 202, the resistance of the force sensitive resistor(s) 210 may change based on such force. These changes in resistance may be utilized to determine the weight of the food item 202, as discussed herein. Advantageously, the use of force sensitive resistors 210 and the associated signal conditioning circuit(s) 212 and other components in accordance with the present disclosure is relatively inexpensive and unaffected by temperature changes. Further, the use of signal conditioning circuit(s) 212 and methods in accordance with the present disclosure advantageously facilitates accurate scale 200 calibration and food item 202 weight determination.

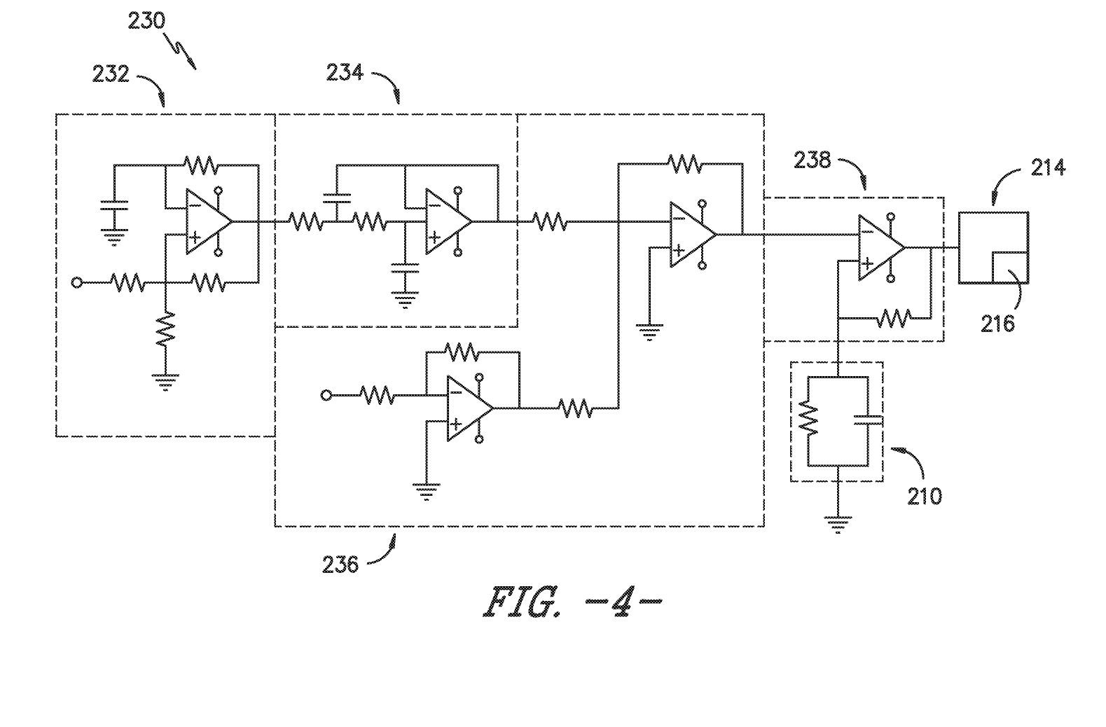

Referring now to FIG. 4, one embodiment of a circuit diagram for signal conditioning circuit 212, a force sensitive resistor 210, and a controller 214 is provided. As illustrated, circuit 212 includes a sine wave generator circuit 230. In the embodiment shown, sine wave generator circuit 230 includes square wave generator circuit 232 and a Sallen-Key generator 234 connected to the sine wave generator circuit 230. A centering and amplifying circuit 236 may be connected to the sine wave generator circuit 230, and a non-inverting amplifier circuit 238 may be connected to the centering and amplifying circuit 236. As illustrated, force sensitive resistor 210 may be connected to the signal conditioning circuit 212, such as to the non-inverting amplifier 238. As further illustrated, controller 214 and analog-to-digital converter 216 thereof may be connected to the signal conditioning circuit 212, such as to the non-inverting amplifier 238.

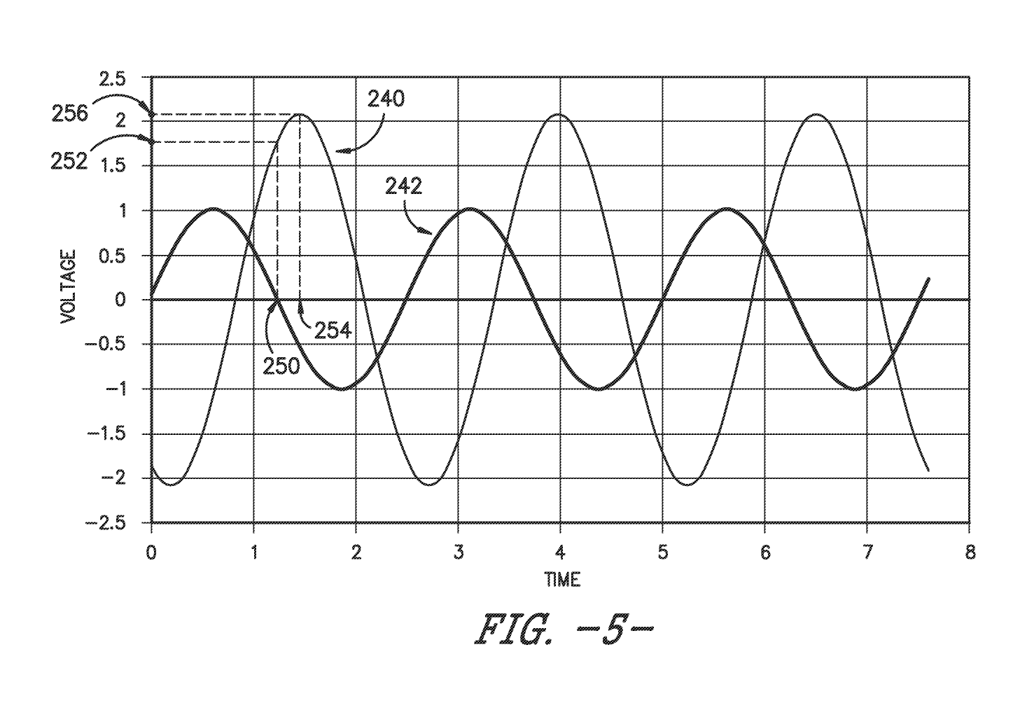

Accordingly, during operation of the scale 200, signals from the force sensitive resistor(s) 210 may be conditioned by the signal conditioning circuit(s) 212 and output to the analog-to-digital converter 216 and controller 214. Referring now to FIG. 5, a graphical representation of outputs from a signal conditioning circuit 212, and thus inputs into the controller 214, is provided. Specifically, a voltage signal 240 and a sine wave generator signal 242 are illustrated. These signals can in exemplary embodiments be measured on a plot of voltage and time. As shown, in exemplary embodiments, each signal 240, 243 has a sine wave pattern. These signals 240, 242 can advantageously be utilized to determine the weight of a food item 202 placed on scale 200.

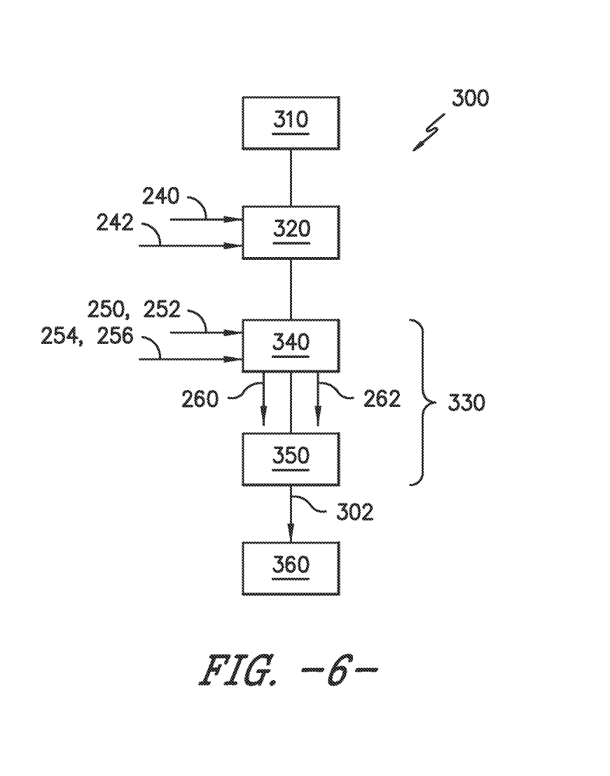

For example, and referring now to FIG. 6, the present disclosure is further directed to methods 300 for determining the weight 302 of a food item 202. Such methods may, in exemplary embodiments, be performed by controller 214, which may be configured for performing such methods. A method may include, for example, the step 310 of receiving a voltage signal 240 and a sine wave generator signal 242, as discussed herein. The method may further include the step 320 of capturing a first voltage signal value 250 at a first trigger datum 252 and a second voltage signal value 254 at a second trigger datum 256, as further illustrated in FIG. 4. In exemplary embodiments, the first and second trigger datums 252, 256 are times, which may for example be predetermined and programmed into the controller 214. For example, in some embodiments as shown, the first trigger datum 252 is a first time at which the sine wave generator signal 242 crosses zero voltage, and the second trigger datum 254 is a second time at which the voltage signal is at a maximum value. Accordingly, the first voltage signal value 250 in these embodiments may be the voltage of voltage signal 240 when the sine wave generator signal 242 crosses zero voltage, and the second voltage signal value 252 may be the maximum voltage of voltage signal 240. In alternative embodiments, first voltage signal value 250 and second voltage signal value 254 may be captured at other suitable times, etc. as desired or required for correlation with and determination of the weight of a food item 202.

A method for determining the weight of a food item 202 may further include, for example, the step 330 of determining the weight of the food item 202 based on the first voltage signal value 250 and the second voltage signal value 254. The first voltage signal value 250 and second voltage signal value 254 may, for example, be correlated with a weight value for a food item 202. In exemplary embodiments, such correlations may be determined empirically through testing using, for example, a particular food item 202 that the scale 200 is intended for use with. Tables, charts and/or graphs of such resulting correlations may be programmed into the controller 214, such that after a first voltage signal value 250 and a second voltage signal value 254 are captured, a corresponding weight may be determined by the controller 214.

In some embodiments, the first and second voltage signal values 250, 254 may be directly correlated with weight values, such that a weight of a food item 202 can be determined based on the first voltage signal value 250 and the second voltage signal value 254. In other embodiments, the step of determining the weight of a food item 202 may further include additional intermediate steps for determining additional values, which may in turn be utilized to determine the weight of a food item 202. For example, in some embodiments, the step 330 of determining the weight of a food item 202 may include the step 340 of determining a gain value and a phase lag value based on the first voltage signal value 250 and the second voltage signal value 254. The gain value and phase lag value can be determined based on such values 250, 254, as well as based on the voltage signal 240 and sine wave generator signal 242, as is generally understood. The step of determining the weight of a food item 202 may then further include, for example, the step 350 of determining the weight 302 based on the gain value 260 and the phase lag value 262. In these embodiments, gain values and phase lag values may, for example, be correlated with weight values for a food item 202, such as through empirical testing, as discussed above.

It should be noted that, while in some embodiments only a single force sensitive resistor 210 is utilized in accordance with a present method 300, in other embodiments, multiple force sensitive resistors 210 may be utilized. When a single force sensitive resistor 210 is utilized, step 330 of determining the weight of the food item 202 may result in the total weight of the food item being determined. When multiple force sensitive resistors 210 are utilized, step 330 may result in a partial weight of the food item being determined for each force sensitive resistor 210. In these cases, method 300 may further include the step of summing the partial weights to produce the weight 302.

In some embodiments, method 300 may further include the step 360 of transmitting the weight 302 to an independent storage device 280. Referring briefly to FIG. 2, one embodiment of an independent storage device 280 is illustrated. The independent storage device 280 may, for example, be in communication with the controller 214, and may thus receive signals from the controller 314 associated with the weight 302 of the food item 202. In some embodiments, a device 280 may be, for example, an independent device such as a “dongle” that the user carries with him/her. In other embodiments a device 280 may be a component of another suitable device that the user carries with him/her, such as a cellular phone, etc. In still other embodiments, a device 280 may be a digital storage drive, such as a “cloud”-based storage. In this manner, a user can view or access the weight 302 of the food item 202 when away from the scale 200, such as when at the grocery store.

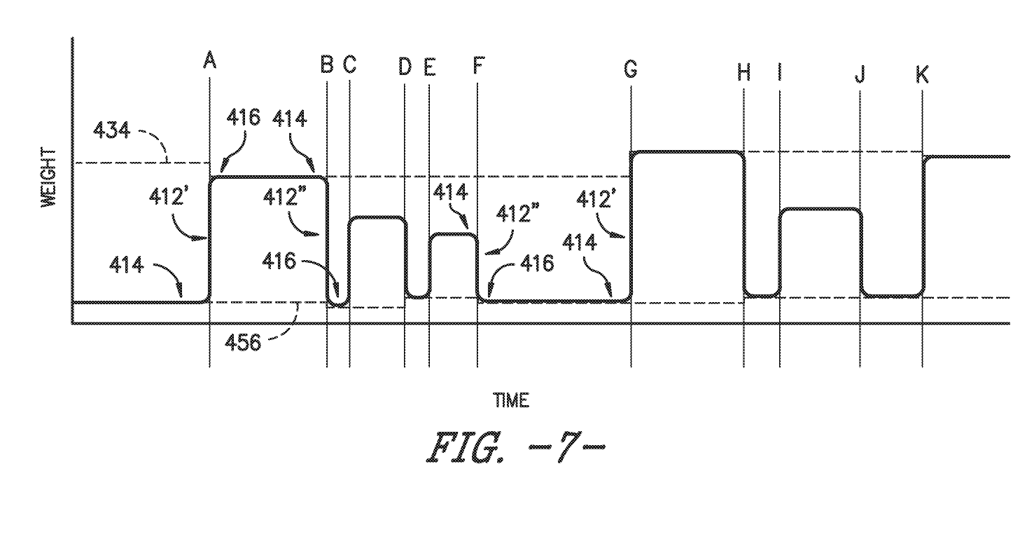

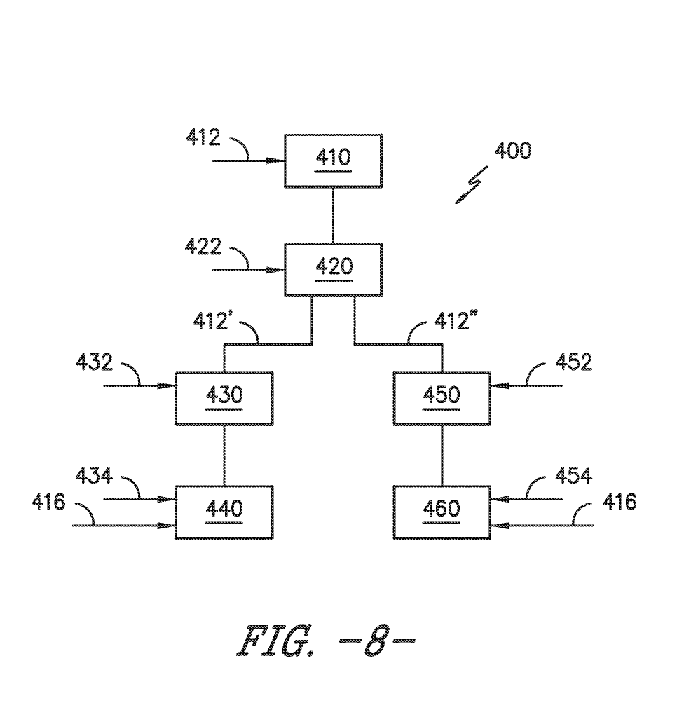

Accordingly, methods 300 and food scales 200 in accordance with the present disclosure can advantageously be utilized to weigh food items 202. Such food scales 200 and the associated methods facilitate inexpensive and accurate weighing. Further, however, to ensure that the weight measurements of food items 202 remains accurate, calibration of the food item scale 200 is required. Accordingly, and referring now to FIGS. 7 and 8, the present disclosure is further directed to methods 400 for calibrating a food item scale 202. A method may include, for example, the step 410 of detecting a food item weight transition 412 from a first weight 414 to a second weight 416. Such transition 412 may occur when, for example, the food item 202 is placed on the scale 200 (causing a positive food item weigh transition 412′) or when the food item 202 is removed from the scale 200 (causing a negative food item weight transition 412″). Positive and negative transitions 412′, 412″ are illustrated in FIG. 7.

In some embodiments, it may be desirable to determine whether a transition 412 is large enough to warrant continuing with the various steps of the method 400 as discussed herein. For example, minor fluctuations in weight between first weight and a second weight, which may for example be due to incidental contact, may not require such continuation. Accordingly, method 400 may further include the step 420 of determining if the food item weight transition 412 exceeds a transition threshold 422. The transition threshold 422 may be a minimum value that must be met or exceeded for continuing in accordance with the present disclosure. Such transition threshold 422 may, for example, be predetermined, and may be programmed into the controller 214. In some embodiments, the transition 412, which may simply be a difference between the first weight and the second weight, may be directly compared to a threshold 422, which in these embodiments may be a weight. In other embodiments, a derivative of the transition 412 (or absolute value thereof) over the associated time period may be calculated, and this derivative may be compared to a threshold 422, which may be a minimum such value.

As discussed, the food item weight transition 412 may be positive or negative. Method 400 may further include, for example, the step 430 of determining, when the food item weight transition 412 is positive, if the second weight 416 is greater than a full weight threshold value 432. In exemplary embodiments, the determining step 430 may only occur when, for example, the food item weight transition 412 exceeds the transition threshold 422. The full weight threshold value 432 may, for example, be a minimum value related to an existing full weight value to which the scale 402 is currently calibrated. The full weight threshold value 432, or equations or instructions for computing it, may for example be predetermined, and may be programmed into the controller 214. In some embodiments, for example, the full weight threshold value 432 is between 90% and 98% of a current full weight value 434, such as between 94% and 98% of the of the current full weight value 434.

Method 400 may further include, for example, the step 440 of setting the full weight value 434 as equal to the second weight 416 when the second weight 416 is greater than the full weight threshold value 432. Accordingly, if the second weight 416 exceeds the full weight threshold value 432, the scale 200 is recalibrated such that the set value that the scale 200 utilizes as the full weight of a food item 202 is set to the second weight 416.

It should again be noted that, while in some embodiments only a single force sensitive resistor 210 is utilized in accordance with a present method 400, in other embodiments, multiple force sensitive resistors 210 may be utilized. When a single force sensitive resistor 210 is utilized, step 440 of setting the full weight value 434 as equal to the second weight 416 may be performed based on the entire second weight 416 and the entire full weight value 434. When multiple force sensitive resistors 210 are utilized, step 440 may include the step of apportioning the second weight 416, such as for each of the plurality of multiple force sensitive resistors 210. In accordance with such step, the portion of the second weight 416 that is attributable to each force sensitive resistor 210 may be calculated. For example, in some embodiments, simultaneous equations may be utilized to solve for the portion of the second weight 416 that is attributable to each force sensitive resistor 210. The lengths from a centerpoint between the force sensitive resistors 210, as well as angles of the resistors 210 to each other relative to the centerpoint, may for example be utilized in such simultaneous equations. The resulting second weight portions attributable to each force sensitive resistor 210 may be summed to equal the second weight 416. After apportioning of the second weight 416, step 440 may further include setting the full weight value portion for each force sensitive resistor 210 to the second weight portion apportioned for that force sensitive resistor 210.

Notably, FIG. 7 illustrates such calibration of the line labelled as the full weight value 434. For example, while step 430 occurs at the transitions 412 marked as A, C, E, G, I and K, step 440 only occurs to reset the full weight value 434 at steps A, G and K.

Additionally or alternatively, method 400 may further include, for example, the step 450 of determining, when the food item weight transition 412 is negative, if the second weight 416 is less than an empty weight threshold value 452. In exemplary embodiments, the determining step 450 may only occur when, for example, the food item weight transition 412 exceeds the transition threshold 422. The empty weight threshold value 452 may, for example, be a maximum value related to an existing full weight value to which the scale 402 is currently calibrated. The empty weight threshold values 452, or equations or instructions for computing them, may for example be predetermined, and may be programmed into the controller 214. In some embodiments, for example, the empty weight threshold value 452 is between 102% and 110% of a current empty weight value 454, such as between 102% and 106% of the current empty weight value 454.

Method 400 may further include, for example, the step 460 of setting the empty weight value 454 as equal to the second weight 416 when the second weight 416 is less than the empty weight threshold value 452. Accordingly, if the second weight 416 is less than the empty weight threshold value 452, the scale 200 is recalibrated such that the set value that the scale 200 utilizes as the empty weight of a food item 202 is set to the second weight 416.

It should once more be noted that, while in some embodiments only a single force sensitive resistor 210 is utilized in accordance with a present method 400, in other embodiments, multiple force sensitive resistors 210 may be utilized. When a single force sensitive resistor 210 is utilized, step 460 of setting the empty weight value 454 as equal to the second weight 416 may be performed based on the entire second weight 416 and the entire empty weight value 454. When multiple force sensitive resistors 210 are utilized, step 440 may include the step of apportioning the second weight 416, such as for each of the plurality of multiple force sensitive resistors 210. In accordance with such step, the portion of the second weight 416 that is attributable to each force sensitive resistor 210 may be calculated. For example, in some embodiments, simultaneous equations may be utilized to solve for the portion of the second weight 416 that is attributable to each force sensitive resistor 210. The lengths from a centerpoint between the force sensitive resistors 210, as well as angles of the resistors 210 to each other relative to the centerpoint, may for example be utilized in such simultaneous equations. The resulting second weight portions attributable to each force sensitive resistor 210 may be summed to equal the second weight 416. After apportioning of the second weight 416, step 440 may further include setting the empty weight value portion for each force sensitive resistor 210 to the second weight portion apportioned for that force sensitive resistor 210.

Notably, FIG. 7 illustrates such calibration of the line labelled as the empty weight value 456. For example, while step 450 occurs at the transitions 412 marked as B, D, F, H and J, step 460 only occurs to reset the full weight value 434 at steps B, D, F and H.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for calibrating a food item scale, the method comprising:
detecting a food item weight transition from a first weight to a second weight;
determining, when the food item weight transition is positive, if the second weight is greater than a full weight threshold value; and
setting a full weight value as equal to the second weight when the second weight is greater than the full weight threshold value.

2. The method of claim 1, wherein the full weight threshold value is between 90% and 98% of the full weight value.

3. The method of claim 1, wherein the full weight threshold value is between 94% and 98% of the full weight value.

4. The method of claim 1, further comprising determining if the food item weight transition exceeds a transition threshold, and wherein the determining step only occurs when the food item weight transition exceeds the transition threshold.

5. The method of claim 1, further comprising:
determining, when the food item weight transition is negative, if the second weight is less than an empty weight threshold value; and
setting an empty weight value as equal to the second weight value when the second weight is less than the empty weight threshold value.

6. The method of claim 5, wherein the empty weight threshold value is between 102% and 110% of the empty weight value.

7. The method of claim 5, wherein the empty weight threshold value is between 102% and 106% of the empty weight value.

8. A method for determining a weight of a food item, the method comprising:
receiving a voltage signal and a sine wave generator signal;
capturing a first voltage signal value at a first trigger datum and a second voltage signal value at a second trigger datum; and
determining the weight based on the first voltage signal value and the second voltage signal value.

9. The method of claim 8, wherein the first trigger datum is a first time at which the sine wave generator signal crosses zero voltage and the second trigger datum is a second time at which the voltage signal is at a maximum value.

10. The method of claim 8, wherein the voltage signal and the sine wave generator signal each have a sine wave pattern.

11. The method of claim 8, wherein the determining step comprises:
determining a gain value and a phase lag value based on the first voltage signal value and the second voltage signal value; and
determining the weight based on the gain value and the phase lag value.

12. The method of claim 8, further comprising transmitting the weight to an independent storage device.

13. A food item scale, comprising:
a force sensitive resistor;
a signal conditioning circuit connected to the force sensitive resistor; and
a controller, the controller configured for:
receiving a voltage signal and a sine wave generator signal from the signal conditioning circuit;
capturing a first voltage signal value at a first trigger datum and a second voltage signal value at a second trigger datum; and
determining a weight of the food item based on the first voltage signal value and the second voltage signal value.

14. The food item scale of claim 13, wherein the first trigger datum is a first time at which the sine wave generator signal crosses zero voltage and the second trigger datum is a second time at which the voltage signal is at a maximum value.

15. The food item scale of claim 13, wherein the voltage signal and the sine wave generator signal each have a sine wave pattern.

16. The food item scale of claim 13, wherein the determining step comprises:
determining a gain value and a phase lag value based on the first voltage signal value and the second voltage signal value; and
determining the weight based on the gain value and the phase lag value.

17. The food item scale of claim 13, wherein the controller comprises an analog-to-digital converter.

18. The food item scale of claim 13, wherein the food item scale further comprises a housing, the force sensitive resistor and signal conditioning circuit disposed within the housing.
